(19) United States
(12) Patent Application Publication
(10) Pub. No.: US 2009/0021427 A1
(43) Pub. Date: Jan. 22, 2009

(54) RECEIVER AND RELATED METHOD FOR SYNCHRONIZING DATA SEGMENTS BY COMPARING REFERENCE TIME DATA AND TIME INFORMATION CARRIED BY DATA SEGMENTS

(76) Inventor: Chien-Liang Tsai, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/779,286

(22) Filed: Jul. 18, 2007

(51) Int. Cl. G01S 1/00; H04B 7/185

(52) U.S. Cl. 342/357.12

(57) ABSTRACT

A method for synchronizing data segments transmitted by a Global Navigation Satellite System (GNSS) signal is disclosed. Each of the data segments has a plurality of data units including a data unit, which contains a plurality of bit positions defined for carrying time information. The method comprises: identifying a specific data unit from a specific data segment; and comparing a reference time data with a plurality of bits of the specific data unit at the bit positions to synchronize the data segments in the GNSS signal.

### BACKGROUND

The present invention relates to a Global Navigation Satellite System (GNSS) receiving scheme, and more particularly, to a receiver and related method for synchronizing data segments transmitted by a GNSS signal.

Generally speaking, a GNSS receiver, such as a GPS (Global Positioning System) receiver, is utilized for receiving navigation data carried by GNSS signals transmitted from various satellites. The GNSS receiver can therefore be located at once according to the received navigation data from the different satellites. Using a GPS receiver as an example, after receiving a GPS signal, it is necessary for the GPS receiver to demodulate the GPS signal and to perform bit synchronization upon the demodulated GPS signal to generate a bit stream. The GPS receiver then performs subframe synchronization upon the bit stream to generate subframes by using preamble bits in the bit stream, so the navigation data can be identified from information carried by the subframes.

However, there exists a problem. Preamble bits in a subframe are positioned before the other bits in the subframe; that is, the preamble bits are starting bits of the subframe. Moreover, in GPS the preamble bits are eight bits and therefore only account for a very small part of the subframe, which has 300 bits. If the GPS receiver misses the preamble bits after it is powered on, it may need to wait several seconds in order to receive the next preamble bits of the next subframe for subframes synchronization. For example, under the worst condition, if the GPS receiver misses the preamble bits due to any bit error of the preamble bits, it is necessary for the GPS receiver to wait almost six seconds to receive the next preamble bits since the required transmission time for each word is equal to 0.6 second and each subframe has ten words. Therefore, the traditional subframe synchronization scheme of a GPS receiver is inefficient. Under this situation, users experience longer time to wait for the first fix after powering on the GPS receiver.

### SUMMARY

It is therefore one of the objectives of the present invention to provide a receiver and related method for synchronizing data segments (subframes) transmitted via a GNSS signal by comparing a reference time data with TOW bits, to solve the above-mentioned problem.

According to an embodiment of the claimed invention, a method for synchronizing data segments transmitted by a Global Navigation Satellite System (GNSS) signal is disclosed. Each of the data segments has a plurality of data units including a data unit containing a plurality of bit positions defined for carrying time information. The method comprises: identifying a specific data unit from a specific data segment; and comparing a reference time data with a plurality of bits of the specific data unit at the bit positions to synchronize the data segments in the GNSS signal.

According to an embodiment of the claimed invention, a receiver for synchronizing data segments transmitted by a GNSS signal is disclosed. Each of the data segments has a plurality of data units including a data unit containing a plurality of bit positions defined for carrying time information. The receiver comprises a data unit checking circuit and a synchronization circuit. The data unit checking circuit is utilized for identifying a specific data unit from a specific data segment. The synchronization circuit is coupled to the data unit checking circuit and utilized for comparing a reference time data with a plurality of bits of the specific data unit at the bit positions to synchronize the data segments in the GNSS signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a GNSS receiver according to an embodiment of the present invention.

FIG. 2 is a diagram showing a format of subframe content in the GPS navigation data.

FIG. 3 a diagram showing formats of a TLM word and an HOW word in the subframe content shown in FIG. 2.

FIG. 4 is a flowchart illustrating an operation of the GNSS receiver shown in FIG. 1.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

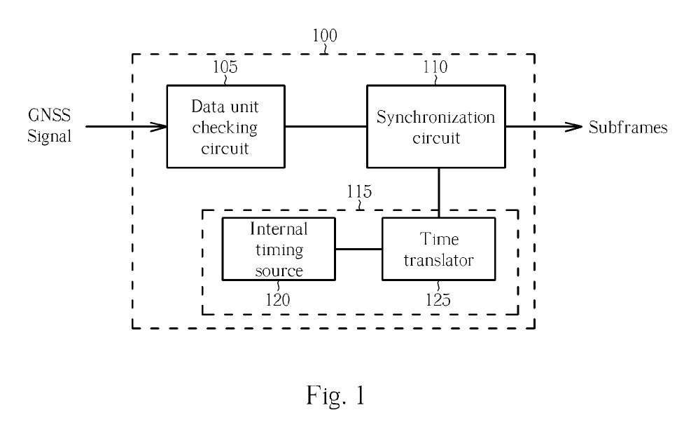

Please refer to FIG. 1. FIG. 1 is a diagram of a GNSS receiver 100 according to an embodiment of the present invention. As shown in FIG. 1, the GNSS receiver 100 includes a data unit checking circuit 105, a synchronization circuit 110, and an internal time data generator 115 having an internal timing source 120 and a time translator 125. The GNSS receiver 100 synchronizes data segments transmitted by a GNSS (Global Navigation Satellite System) signal, where each of the data segments has a plurality of data units. A data unit included within the data units contains a plurality of bit positions defined for carrying time information. The data unit checking circuit 105 is utilized for identifying a specific data unit from a specific data segment in the GNSS signal; the synchronization circuit 110 is utilized for comparing a reference time data, which is generated by the internal time data generator 115, with a plurality of bits of the specific data unit at the bit positions to synchronize the data segments in the GNSS signal. In particular, the synchronization circuit 110 determines whether a value represented by the bits of the specific data unit at the bit positions falls within a predetermined range corresponding to the reference time data. The synchronization circuit 110 then synchronizes the data segments according to the specific data unit if the value falls within the predetermined range. Of course, if accuracy is considered, the synchronization circuit 110 can change to determine whether the value represented by the bits of the specific data unit at the bit positions matches the reference time data. The synchronization circuit 110 then synchronizes the data segments according to the specific data unit if the value matches the reference time data.

In this embodiment, the GNSS signal is a GPS signal, and the data segments are subframes. The data units are words in the subframes, and the time information is meant to be a time of week (TOW) count message. That is, the specific data unit is a hand over word (HOW) word, and the value represented by the bits of the specific data unit at the bit positions is meant to be a value represented by the TOW count message (i.e. TOW bits) in the HOW word. The method disclosed in this description, of course, can also be applied to other GNSS receivers based on the GLONASS navigation system, Beidou navigation system, Galileo positioning system, or other current and proposed global navigation systems. These applications also obey the spirit of the present invention.

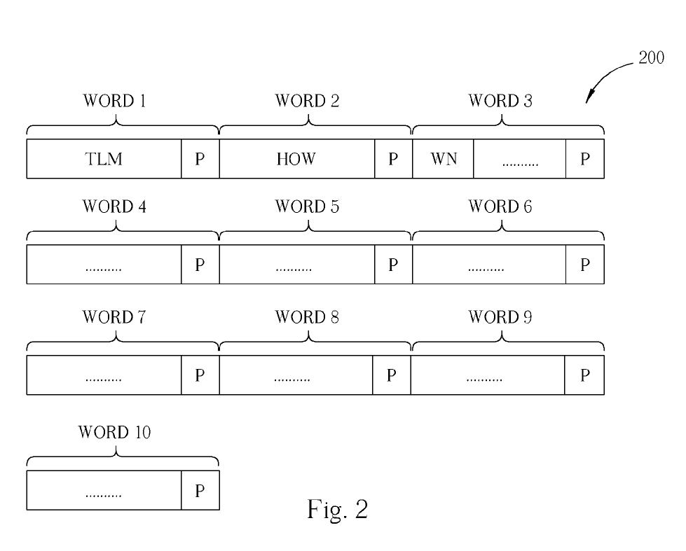

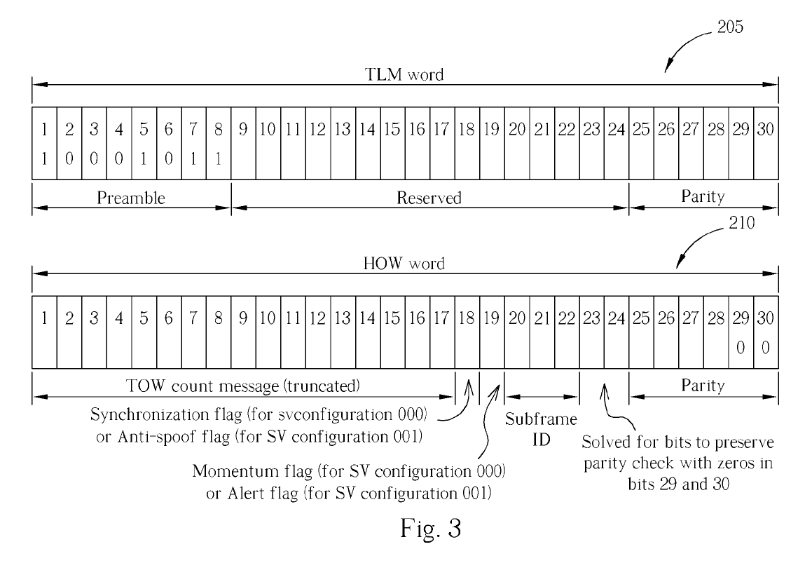

As regards GPS navigation data, a frame in the GPS navigation data is comprised of five kinds of subframes, where each of the subframes includes a telemetry (TLM) word including preamble bits, an HOW word, and other words defining various satellite orbit parameters. Please refer to FIG. 2 in conjunction with FIG. 3. FIG. 2 shows a format of subframe content 200 in the GPS navigation data. FIG. 3 shows formats of a TLM word 205 and an HOW word 210 in the subframe content 200 shown in FIG. 2. As shown in FIG. 2, the subframe content 200 includes ten words, and each word has thirty bits carrying information for different operations. For example, information carried by WN bits, which is exclusively for subframe 1, is meant to be a week number, and information conveyed by ‘P’ bits in each word is used for parity check. As shown in FIG. 3, the TLM word 205 includes preamble bits, reserved bits, and parity bits (for parity check); the HOW word 210 includes TOW bits representative of TOW (time-of-week) count message (truncated), bits for defining subframe ID, parity bits, and other different flags. Accordingly, the reference time data (having a bit number identical to that of the TOW bits) can be taken as a reference to be compared with the TOW bits. For instance, when the GNSS receiver 100 misses preamble bits of the TLM word 205 but not all the TLM word 205, it can still rapidly perform subframe synchronization of the subframe content 200 by comparing the reference time data with the TOW bits of the HOW word 210, without waiting for next preamble bits of next subframe content.

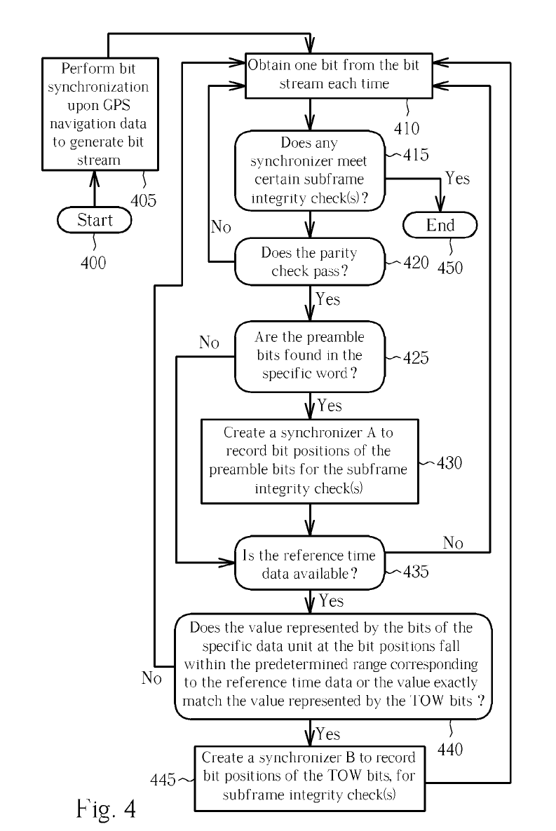

Please refer to FIG. 4. FIG. 4 is a flowchart illustrating an operation of the GNSS receiver 100 shown in FIG. 1. A description regarding steps of this flowchart is detailed as follows:
Step 400: Start.
Step 405: Perform bit synchronization upon GPS navigation data to generate a bit stream.
Step 410: Obtain one bit (i.e. an incoming bit) from the bit stream each time; for example, get one bit from the bit stream every 20 ms.
Step 415: Does any synchronizer meet certain subframe integrity check(s)? If a synchronizer meets certain subframe integrity check(s), this means that the synchronizer recording the bit positions of the preamble/TOW bits is a valid solution for subframe synchronization; go to Step 450. Otherwise, the GNSS receiver 100 treats the incoming bit as the last bit of a word to perform a parity check, for getting words from the bit stream; go to Step 420.
Step 420: Does the parity check pass? If the parity check passes, this means that a specific word is obtained by the parity check, and go to Step 425; otherwise, go to Step 410.
Step 425: Are the preamble bits found in the specific word? If the preamble bits are found in the specific word, the specific word is meant to be a TLM word, and go to Step 430 for creating a synchronizer for subframe synchronization. Otherwise, if the preamble bits are not matched, there is still some possibility that the specific word is an HOW word, in which the TOW bits can be utilized for subframe synchronization; go to Step 435.
Step 430: Create a synchronizer A to record bit positions of the preamble bits for the subframe integrity check(s).
Step 435: Is the reference time data available? If the reference time data is available, go to Step 440; otherwise, go to Step 410.
Step 440: Does the value represented by the bits of the specific data unit at the bit positions (i.e. TOW bits) fall within the predetermined range corresponding to the reference time data or the value exactly match the value represented by the TOW bits? If the value falls within the predetermined range or matches the value represented by the TOW bits, go to Step 445; otherwise, go to Step 410.
Step 445: Create a synchronizer B to record bit positions of the TOW bits, for subframe integrity check(s).
Step 450: End.

The subframe integrity check(s) is/are used for checking to see if the created synchronizer A/B certainly records the bit positions of the preamble/TOW bits in the bit stream. This is because information carried by the GPS signal may be erroneous due to noise. Without the subframe integrity check(s), this may cause a bit value represented by the information erroneously to become the value represented by the preamble bits or the TOW bits. Accordingly, by the subframe integrity check(s), it can be ensured that the created synchronizer A/B records the bit positions of the preamble/TOW bits in the bit stream instead of positions of bits represented by any erroneous information. Taking an example of the subframe integrity check(s) for the synchronizer A, the GNSS receiver 100 records TOW bits in a word next to the specific word (i.e. the TLM word) and then checks to see if bits of the next subframe at the same bit positions, which are recorded by the synchronizer A, match the preamble bits. Since the created synchronizer A means that the specific word is a TLM word, bit positions of TOW bits in a next subframe can be located. The GNSS receiver 100 can also check to see if a value represented by the TOW bits of the next subframe is equal to one plus the value represented by the recorded TOW bits in the current subframe.

Similarly, when performing the subframe integrity check(s) for the synchronizer B, the GNSS receiver 100 can check to see if a value represented by the WN bits is valid for subframe 1. The GNSS receiver 100 also checks to see if bits of a next subframe at a starting position match the preamble bits and checks to see if a value represented by the TOW bits of the next subframe is equal to one plus the value represented by the TOW bits that are recorded by the GNSS receiver 100. Of course, these subframe integrity checks mentioned above are not intended to be limitations of the present invention. Other different subframe integrity checks can also be applied to this embodiment. Additionally, the subframe integrity check(s) is/are flexible and therefore can be modified or excluded from the above-described Steps.

It should be noted that the above-mentioned reference time data in this embodiment is the result of a collaboration between the internal timing source 120 and the time translator 125. The internal timing source 120 provides a reference clock to generate reference clock information, and the time translator 125 translates the reference clock information into the reference time data. For example, the reference clock can be an RTC (real time clock) oscillating circuit, and the reference clock information is real-time; the time translator 125 translates the real-time outputted from the RTC oscillating circuit into the reference time data. However, in another embodiment, the internal timing source 120 can be excluded from the internal time data generator 115. Required reference clock information is retrieved from an external timing source (for example, from an internet server or a base station of a wireless network) to the GNSS receiver 100, and the time translator 125 translates the retrieved reference clock information into reference time data. Of course, in other embodiments, if an external time data generator (not in the GNSS receiver 100) able to generate reference time data directly exists, the internal time data generator 115 is not required and therefore can be excluded from the GNSS receiver 100. The GNSS receiver 100 will directly retrieve the reference time data from the external time data generator.

Those skilled in the art will readily observe that numerous modifications and alterations of the device and method may be made while retaining the teachings of the invention.

What is claimed is:

1. A method for synchronizing data segments transmitted by a Global Navigation Satellite System (GNSS) signal, each of the data segments having a plurality of data units including a data unit containing a plurality of bit positions defined for carrying time information, the method comprising:
identifying a specific data unit from a specific data segment; and
comparing a reference time data with a plurality of bits of the specific data unit at the bit positions to synchronize the data segments in the GNSS signal.

2. The method of claim 1, wherein the GNSS signal is a Global Positioning System (GPS) signal, the data segments are subframes, and the time information is a time of week (TOW) message.

3. The method of claim 1, wherein the GNSS signal is received by a GNSS receiver, and the method further comprises:
utilizing an internal time data generator in the GNSS receiver to generate the reference time data.

4. The method of claim 3, wherein the step of utilizing the internal time data generator in the GNSS receiver to generate the reference time data comprises:
providing an internal timing source, and utilizing the internal timing source to generate a reference clock information; and
translating the reference clock information into the reference time data.

5. The method of claim 3, wherein the step of utilizing the internal time data generator in the GNSS receiver to generate the reference time data comprises:
retrieving a reference clock information from a timing source external to the GNSS receiver; and
translating the reference clock information into the reference time data.

6. The method of claim 1, wherein the GNSS signal is received by a GNSS receiver, and the method further comprises:
retrieving the reference time data from a time data generator external to the GNSS receiver.

7. The method of claim 1, wherein the step of comparing the reference time data with the bits of the specific data unit at the bit positions comprises:
determining whether a value represented by the bits of the specific data unit at the bit positions falls within a predetermined range corresponding to the reference time data; and
if the value falls within the predetermined range, synchronizing the data segments according to the specific data unit.

8. The method of claim 1, wherein the step of comparing the reference time data with the bits of the specific data unit at the bit positions comprises:
determining whether a value represented by the bits of the specific data unit at the bit positions matches the reference time data; and
if the value matches the reference time data, synchronizing the data segments according to the specific data unit.

9. A receiver for synchronizing data segments transmitted by a Global Navigation Satellite System (GNSS) signal, each of the data segments having a plurality of data units including a data unit containing a plurality of bit positions defined for carrying time information, the receiver comprising:
a data unit checking circuit, for identifying a specific data unit from a specific data segment; and
a synchronization circuit, coupled to the data unit checking circuit, for comparing a reference time data with a plurality of bits of the specific data unit at the bit positions to synchronize the data segments in the GNSS signal.

10. The receiver of claim 9, wherein the GNSS signal is a Global Positioning System (GPS) signal, the data segments are subframes, and the time information is a time of week (TOW) message.

11. The receiver of claim 9, further comprising:
an internal time data generator, coupled to the synchronization circuit, for generating the reference time data.

12. The receiver of claim 11, wherein the internal time data generator comprises:
an internal timing source, for providing a reference clock to generate a reference clock information; and
a time translator, coupled to the internal timing source, for translating the reference clock information into the reference time data.

13. The receiver of claim 11, wherein the internal time data generator retrieves a reference clock information from an external timing source out of the GNSS receiver and translates the reference clock information into the reference time data.

14. The receiver of claim 9, further retrieves the reference time data from a time data generator external to the GNSS receiver.

15. The receiver of claim 9, wherein the synchronization circuit determines whether a value represented by the bits of the specific data unit at the bit positions falls within a predetermined range corresponding to the reference time data; and if the value falls within the predetermined range, the synchronization circuit synchronizes the data segments according to the specific data unit.

16. The receiver of claim 9, wherein the synchronization circuit determines whether a value represented by the bits of the specific data unit at the bit positions matches the reference time data; and if the value matches the reference time data, the synchronization circuit synchronizes the data segments according to the specific data unit.
